(19) United States
(12) Patent Application Publication
(10) Pub. No.: US 2025/0127078 A1
(43) Pub. Date: Apr. 24, 2025

(54) SYSTEM AND METHOD TO CONTROL MERGER OPERATIONS

(71) Applicant: Deere & Company, Moline, IL (US)

(72) Inventors: Mahesh Somarowthu, Pune (IN); Pritesh K. Ugale, Pune (IN); Nilesh Jadhao, Pune (IN); Kewal K. Ukunde, Pune (IN); Darin L. Roth, Batavia, IA (US)

(21) Appl. No.: 18/492,003

(22) Filed: Oct. 23, 2023

(51) Int. Cl. A01D 34/00; A01D 57/20; A01D 61/00; A01D 69/00

(52) U.S. Cl. CPC A01D 34/006; A01D 57/20; A01D 61/002; A01D 69/00

(57) ABSTRACT

A header and a crop merger are operably attached to a harvester, wherein the crop merger receives cut crop from the header. A controller is operably connected with the header and the crop merger to determine if the header is approaching a headland or crop to cut. The controller receives one or more of a merger belt speed provided by a belt speed sensor associated with a crop belt of the crop merger, a maximum crop flow distance, and a merger belt motor pressure provided by a merger belt motor pressure sensor associated with a motor of the crop merger to determine whether to actuate a crop merger actuator to raise or lower the crop merger as the header approaches the headland. The controller receives harvester system inputs that include at least vehicle speed and cutter width of the header to identify the headland.

### FIELD OF THE DISCLOSURE

The present disclosure relates to a header and a crop merger for a work machine, and in particular to controlling the raising and lowering of the header and the crop merger.

### BACKGROUND OF THE DISCLOSURE

Harvesters such as windrowers, tractors, forage harvesters, and mowers (e.g., self-propelled) generally include a header operable to cut crop. Typical construction for such harvesters include a cab mounted to a frame, front ground wheels mounted on the frame, rear ground wheels mounted on a respective caster, and a header mounted to the frame. Some headers cut crop and feed the crop through the header such that the crop is output underneath the harvester, forming a windrow at a position substantially aligned with the center of the front ground wheels. Some harvesters include a crop merger that receives the crop from the header and outputs the crop to one side of the windrower or harvester, forming a windrow at a position substantially parallel to the direction of travel of the harvester.

The header discharges cut crop material onto a crop merger wherein the crop merger discharges the cut crop material to the right of the harvester. When the windrower or harvester reaches the edge of the field that is to be harvested or a headland, the windrower or harvester turns to start another parallel pass of the field and continues cutting the crop material in a merging operation. When the windrower or harvester reaches the end of crop that is to be harvested or the headland, the crop merger and the header are lifted or raised and rotated to the previous pass or windrow wherein the crop merger then drops or discharges the cut crop material in a belly dump operation. Both the crop merger and the header are lifted to avoid re-cutting or re-processing the cut crop on the ground which is detrimental to and damages the cut crop.

The operator must manually make these timing decisions when to lift the header, when to exit the crop edge, and when to lift the crop merger. These operations can be timed inappropriately since these operations are dependent on the travel speed of the windrower or harvester and the velocity with which the windrower or harvester is approaching the already cut windrowed crop material. For example, if the crop merger is lifted before the crop merger has exited the already cut crop area then this operation can cause the crop merger to dump the cut crop in a belly dump on the ground for the last portion of the windrow. In other words, the cut crop was placed in a windrow until the operator reached the edge of the crop or headland and had to turn the windrower or harvester to start another parallel pass of the field in a merging operation which resulted in a change of direction and travel speed.

Thus there is a need for improvement for controlling the header and the crop merger for the windrower or harvester at a headland.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for operating a harvester machine, the method may include: determining, via a controller, whether a header operably attached to the harvester machine is approaching a headland; in response to the header approaching the headland, determining, via the controller, whether a crop merger operably attached to the harvester is in a low position; in response to the crop merger being in the low position, determining, via the controller, an amount of crop material on the crop merger using one or more of a merger belt speed provided by a belt speed sensor associated with a crop belt of the crop merger, a maximum crop flow distance, and a merger belt motor pressure provided by a merger belt motor pressure sensor associated with a motor of the crop merger; determining, via the controller, whether a crop material remains on the crop merger by the merger belt motor pressure provided by the merger belt motor pressure sensor associated with the motor of the crop merge; and commanding via the controller a crop merger actuator to move the crop merger to a raised position when the crop merger does not contain the crop material. Other embodiments of this aspect include corresponding computer systems, apparatus, and computer programs recorded on one or more computer storage devices, each configured to perform the actions of the methods.

Implementations may include one or more of the following features. In one embodiment, may include: determining a time period required for dispersion of the crop material from the crop belt of the crop merger. In one embodiment, may include: after the time period has passed, then the determining via the controller whether the crop material remains on the crop merger. In one embodiment, may include: receiving a user command from an operator via a user interface operably connected with the controller to enable the controller to perform automatically. In one embodiment, may include: receiving one or more operational inputs from the operator via the user interface that includes any of a maximum ground speed of the harvester, a minimum ground speed of the harvester, a maximum delay time between raising the header and raising the crop merger, a minimum delay time between raising the header and raising the crop merger, a maximum delay time between lowering the header and lowering the crop merger, a minimum delay time between lowering the header and lowering the crop merger. In one embodiment, may include: the commanding via the controller the crop merger actuator to move the crop merger to a raised position is performed automatically. In one embodiment, may include: wherein the determining, via the controller, whether the header operably attached to the harvester machine is approaching the headland includes receiving one or more harvester system inputs that identify the headland. In one embodiment, may include: wherein the harvester system inputs include any of a power drop in engine load input of the header, a perception based crop height input, a header load input, a swath flap load input, a manual scouting input, a predictive map boundary input, a geographical map input, a field boundary input, a cultivation direction input, a cutter width of the header, and a vehicle speed input. In one embodiment, may include: wherein in response to the header approaching the headland, commanding via the controller one or more header actuators to raise the header to a raised position. In one embodiment, may include: determining via the controller whether crop is present on the ground for harvesting by an imaging unit that detects crop, the imaging unit mounted on the header and/or the crop merger and operably connected to the controller; and commanding via the controller a header actuator to lower the header to a harvesting mode of operation to cut the crop in response to determining crop is present on the ground. In one embodiment, may include: determining via the controller whether merging of the cut crop is required; detecting the cut crop from the imaging unit. In one embodiment, may include: wherein the determining whether merging of the cut crop is required includes detecting a windrow of cut crop on the ground or detecting a predefined merging strategy; and in response to detecting the windrow, commanding via the controller actuating a crop merger actuator to lower the crop merger belt to a lowered position. Implementations of the described techniques may include hardware, a method or process, or computer software on a computer-accessible medium.

One general aspect may include: receiving one or more operational inputs from the operator via the user interface that includes any of a maximum ground speed of the harvester, a minimum ground speed of the harvester, a maximum delay time between raising the header and raising the crop merger, a minimum delay time between raising the header and raising the crop merger, a maximum delay time between lowering the header and lowering the crop merger, a minimum delay time between lowering the header and lowering the crop merger. Other embodiments of this aspect include corresponding computer systems, apparatus, and computer programs recorded on one or more computer storage devices, each configured to perform the actions of the methods.

One general aspect may include a harvester machine, may include: a header operably attached to the harvester machine; a crop merger operably attached to the harvester machine, the crop merger configured to receive cut crop from the header; a controller operably connected with the header and the crop merger, the controller configured to determine if the header is approaching a headland; where the controller is configured to determine whether the crop merger is in a low position in response to the header approaching the headland; in response to the crop merger being in the low position, the controller is configured to determine if a crop material is present on the crop merger using one or more of a merger belt speed provided by a belt speed sensor associated with a crop belt of the crop merger, a maximum crop flow distance, and a merger belt motor pressure provided by a merger belt motor pressure sensor associated with a motor of the crop merger; and in response to substantially no crop material remaining on the crop merger, the controller is configured to command a crop merger actuator to move the crop merger to a raised position. Other embodiments of this aspect include corresponding computer systems, apparatus, and computer programs recorded on one or more computer storage devices, each configured to perform the actions of the methods.

Implementations may include one or more of the following features. In one embodiment, where the controller is configured to receive the merger belt motor pressure provided by the merger belt motor pressure sensor associated with the motor of the crop merger to determine whether the crop material remains on the crop merger. In one embodiment, where the controller determines a time period required for dispersion of the crop material from the crop belt of the crop merger. In one embodiment, may include: a user command received from an operator via a user interface operably connected with the controller to enable the controller to perform automatically. In one embodiment, may include: where in response to the header approaching the headland, the controller is configured to command one or more header actuators to raise the header to a raised position. In one embodiment, may include: where the controller is configured to determine if there is crop in a field for harvesting by an imaging unit that detects crop, the imaging unit mounted on the header and/or the crop merger and operably connected to the controller; and the controller is configured to command a header actuator to lower the header to a harvesting mode of operation to cut the crop in response to crop being present for harvesting. In one embodiment, may include: where the controller is configured to determine whether the cut crop should be merged; and where the controller is configured to detect the cut crop from an imaging unit mounted on the header and/or the crop merger. In one embodiment, may include: where the controller is configured to detect a windrow of cut crop on the ground; and in response to the detected windrow, the controller is configured to actuate a crop merger actuator to lower the crop merger belt to a lowered position. Implementations of the described techniques may include hardware, a method or process, or computer software on a computer-accessible medium.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a side view of an exemplary harvester of the present disclosure including a header and a crop merger;

FIG. 2 is a bottom view of an exemplary crop merger of FIG. 1;

FIG. 3a is front view of a first embodiment of an exemplary graphical user interface of FIG. 1;

FIG. 3b is front view of a second embodiment of an exemplary graphical user interface of FIG. 1;

FIG. 3c is front view of a third embodiment of an exemplary graphical user interface of FIG. 1;

FIG. 3d is front view of a fourth embodiment of an exemplary graphical user interface of FIG. 1;

FIG. 4 is a block diagram of system inputs for a controller of the header and crop merger of FIG. 1;

FIG. 5 is a block diagram of operation of a headland and crop detection module of the header and crop merger of FIG. 1; and

FIG. 6 is a flowchart of an exemplary method of operating the header and crop merger of FIG. 1.

Corresponding reference numerals are used to indicate corresponding parts throughout the several views.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

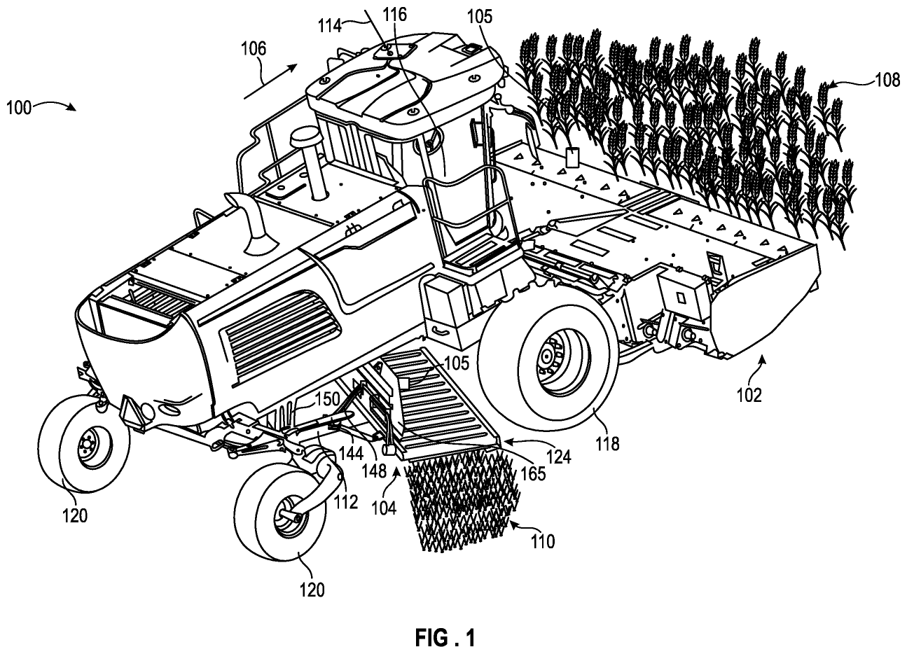

Referring now to FIG. 1, shows a side view of an exemplary harvester 100 including a header 102 at the front of the harvester 100 and a crop merger 104 disposed below the harvester 100. It should be understood that the crop merger 104 discussed herein can be attached and/or interchanged with any type of harvester 100. As the harvester 100 moves in a forward direction of travel 106, the header 102 is configured to cut and intake crop 108 via a mowing or cutting means. The header 102 includes a conveyor 107 over which the cut crop 108 travels or passes to reach the crop merger 104. The cut crop 108 passes through the header 102 and onto the crop merger 104, which outputs the crop 110 on the side of the harvester 100 in the form of a windrow. The windrow of the output crop 110 extends substantially parallel to the direction of travel 106 of the harvester 100. The header 102 includes one or more header actuators or cylinders 103 configured to raise and lower the header 102. The cylinders 103 can include electric cylinders, hydraulic cylinders, or pneumatic cylinders. The harvester 100 includes a pair of front wheels 118 mounted to the frame 112, and a pair of rear caster wheels 120.

As will be discussed in greater detail below, the harvester 100 includes a controller 180 having a headland and crop detection module 200 to receive and process one or more system inputs 202 from the harvester 100. The controller 180 also includes a header and crop merger method 300 to receive one or more system inputs 302 from the harvester 100. As the harvester 100 travels along the field and the header 102 approaches a headland or a crop edge, the controller 180 is configured to cause the harvester 100 to automatically raise and/or lower the header 102 and/or the crop merger 104 based on the headland and crop detection module 200 and the header and crop merger method 300 as described below.

The harvester 100 can optionally include one or more cameras or imaging units 105 placed on any of the header 102, the crop merger 104, and/or the harvester 100. The harvester 100 includes one or more sensors including at least one of a belt speed sensor 176, 178 and a merger belt motor pressure sensor 182 placed on the crop merger 104. In the illustrated embodiment, a first of the imaging unit 105 is mounted on the header 102 and a second of the imaging unit 105 is mounted on the crop merger 104. The first and second imaging units 105 are operatively coupled to the controller 180 that detects and may continuously or substantially continuously provide information to the controller 180 or other suitable device to identify one or more system inputs 202, a header camera input 308, and/or a merger camera input 310 as described below. The first and second imaging units 105 can be part of a visual system that includes a structured light unit and a general illumination light. The general illumination light can include one or more light emitting diodes (LED) or broad-beamed, high intensity artificial light. The general illumination light can be used with the structured light unit. In some embodiments, the controller 180 is included in the visual system. In other embodiments, the controller 180 is operatively coupled to the visual system. Although the visual system is described in the application, it should be appreciated that other types of sensing technology that are not “visual” can be used with the present disclosure. Some non-limiting examples include radar, LiDAR or light detection and ranging, ultrasonic, radio waves, electromagnetic waves, to name a few.

One or more of the belt speed sensors 176, 178 (e.g., an optical sensor, a non-contact sensor, a mechanical sensor, a rotary sensor, or the like) are added to the control circuit associated with the crop merger 104 to detect a hydraulic and/or electric motor speed input 304 driving the crop merger belt. The motor speed input 304 is one of the system inputs 302 for the header and crop merger method 300. In some embodiments, the belt speed sensors 176, 178 can be used to detect, e.g., the speed of the shaft associated with rotation of the crop merger belt, the speed of the crop merger belt itself, the speed of the roller associated with rotation of the crop merger belt, combinations thereof, or the like. In some embodiments, the belt speed sensors 176, 178 can be integral to the motor and/or external to the motor, and measures the motor shaft speed as the motor speed input 304. From the motor shaft speed, the linear belt speed of the crop merger 104 can be determined as the motor speed input 304. In some embodiments, a combination of multiple speed sensors can be used and the signals from each belt speed sensor 176, 178 can be compared prior to transmission of adjustments to the controller 180 to ensure the accuracy of the adjustments.

In some embodiments, a hydraulic motor, an electric motor, or both, can be used to power the crop merger 104. The motor can be mounted directly or indirectly to the drive roller of the merger belt. A pump of the crop merger 104 can be a fixed or variable displacement pump, with flow being proportional to the engine speed of the harvester 100. The belt speed is thereby controlled by a proportional cartridge valve varying the flow to the drive motor based on the desired belt speed set by the operator via a graphical user interface (GUI). By using the belt speed sensors 176, 178, a closed loop control of the crop merger belt is implemented to constantly or substantially constantly monitor the crop merger belt speed in real-time. In some embodiments, rather than a constant monitoring, the belt speed sensors 176, 178 can periodically measure the crop merger belt speed such that adjustments are performed periodically (e.g., once every 30 seconds, once every minute, once every five minutes, or the like). A feedback loop sending signals to the controller 180 regarding the detected crop merger belt speed can be used to automatically adjust the proportional valve to maintain the crop merger belt speed set by the operator regardless of changes in crop loads. In some embodiments, the motor and belt can rotate in either the clockwise or counterclockwise direction. In such embodiments, the speed can be adjusted to the desired speed in either direction. In some embodiments, the desired speeds can be different depending on the direction of rotation.

The crop merger 104 removes the necessity for physical calibration when installing and setting up a crop merger to ensure that the merger belt set speed by the operator matches the actual measured belt speed. Because the crop merger 104 detects the actual measured speed associated with the belt (whether the belt itself, the motor shaft, or the roller), the necessity of calibrating the control current to the proportional valve such that the valve provides the correct amount of flow to the motor to achieve the desired belt set speed is also removed. Instead, the closed loop control of the crop merger 104 ensures that the belt speed is maintained at the speed set by the operator throughout operation of the harvester 100, and adjusts for changes in crop loads, hydraulic fluid flow, or the like.

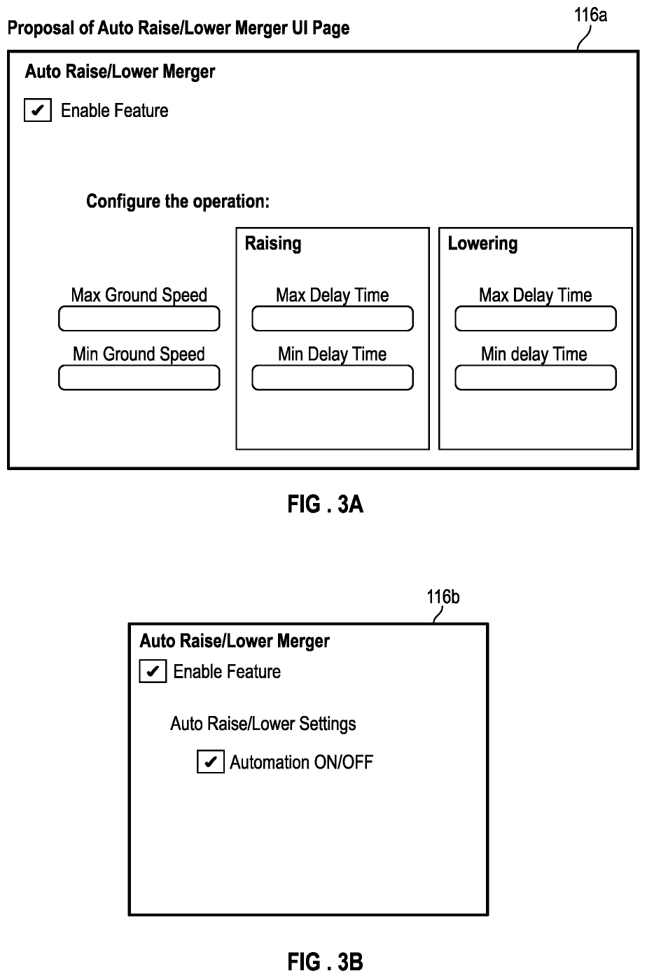

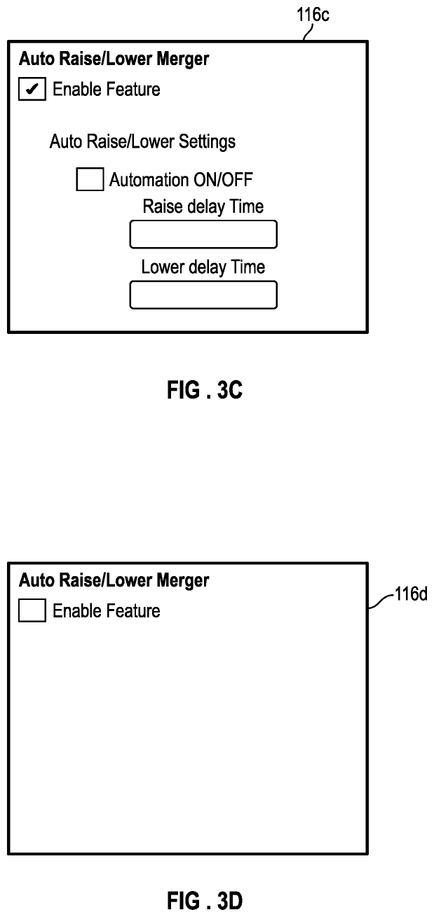

Still with reference to FIG. 1, the harvester 100 includes a frame 112, and a cab 114 mounted to the frame 112 and including a graphical user interface (GUI) 116. The GUI 116 can be configured to receive one or more inputs from the operator as illustrated in GUI 116a, 116b, 116c, and 116d as illustrated in FIGS. 3a, 3b, 3c, and 3d. For example, the GUI 116a can be configured to receive input from the operator (e.g., an enablement of automatic operation of the header 102 and crop merger 104, a maximum ground speed of the harvester 100, a minimum ground speed of the harvester 100, a maximum delay time between raising the header 102 and raising the crop merger 104, a minimum delay time between raising the header 102 and raising the crop merger 104, a maximum delay time between lowering the header 102 and lowering the crop merger 104, a minimum delay time between lowering the header 102 and lowering the crop merger 104, or the like) for operating the harvester 100, the header 102, and the crop merger 104. For example, the GUI 116b can be configured to receive input from the operator (e.g., an enablement of automatic operation of the header 102 and crop merger 104 and an automatic operation of raising and lowering the header 102 and the crop merger 104) however in this embodiment the operator cannot manually set any time limits. For example, the GUI 116c can be configured to receive input from the operator (e.g., an enablement of automatic operation of the header 102 and crop merger 104, an automatic operation of raising and lowering the header 102 and the crop merger 104, a raise delay time, and a lower delay time). For example, the GUI 116d can be configured to receive input from the operator including an enablement of automatic operation of the header 102 and crop merger 104 however in this embodiment the operator cannot manually input other information.

Although not illustrated in FIGS. 3a-3d, a headland pass distance and/or type of cutting head for the header 102 may be entered by the operator in the GUI 116a-116d. The width of the cutting pass varies based on the width of the cutting head of the header 102. The headland pass distance is measured between the edge of the cutting pass and the formed windrow and is dependent on the width of the specific cutting head of the header 102. As such, the headland pass distance can vary based on the width of the cutting head attached to the header 102. The delay times between raising/lowering the header 102 and raising/lowering the crop merger 104 are dependent on velocity change as the header 102 enters the headland and is also dependent on the distance traveled to miss the next windrow. An operator may want to utilize all of the headland pass distance for a wider cutting head of the header 102 as compared to the headland pass distance for a smaller or narrower head of the header 102. Any of the GUI 116a-116d can be configured to display output to the operator information associated with the harvester 100, the header 102, and the crop merger 104.

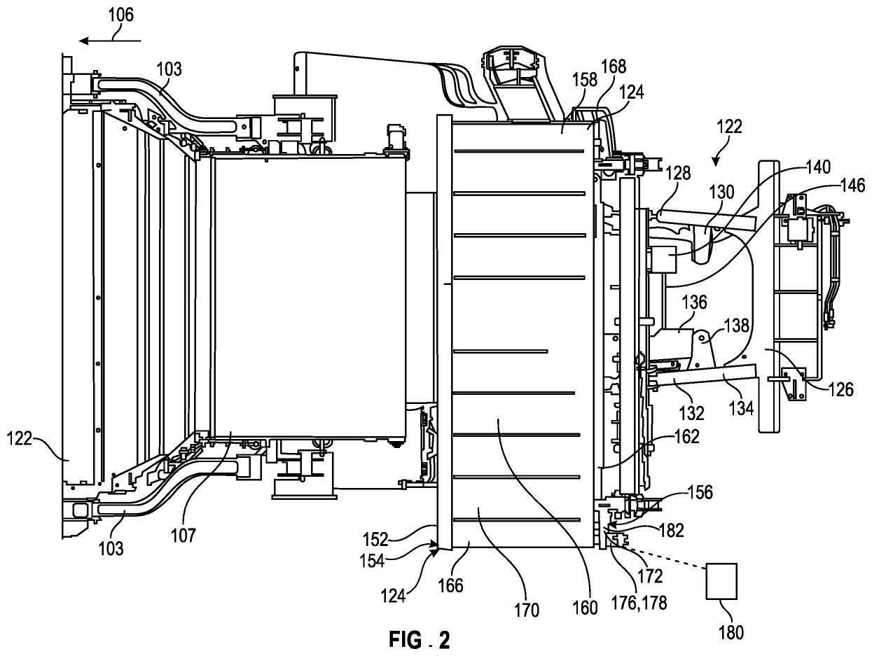

FIG. 2 illustrates a bottom view of one embodiment of the crop merger 104. The crop merger 104 generally includes a mounting assembly 122 operably coupled to a belt assembly 124. The mounting assembly 122 is configured and dimensioned to be mounted to the bottom of the frame 112 of the harvester 100 by means of adapter assemblies 130, 134 (e.g., flanges, cross members, or the like). The mounting assembly 122 generally includes a central frame member 126 defining, e.g., a parallelogram, square or rectangular configuration. The frame member 126 can be formed from one or more structural elements coupled together. The mounting assembly 122 includes a substantially linear mounting assembly 134 coupled to the top of the frame member 126 between the ends 128, 132. One end 128 of the frame member 126 can include an adapter assembly 130 mounted to the frame member 126, such that the adapter assembly 130 and an opposing end 132 of the frame member 126 can be coupled to the bottom of the frame 112 of the harvester 110 via the mounting assembly 134. For example, adapter assemblies 130, 134 can be used to secure the central frame member 126 to the frame 112.

The frame member 126 can include provisions for a hydraulic connection bulkhead, ensuring proper routing and alignment of the hydraulic hoses such that the hoses avoid interferences with other harvester 100 components. A first linkage 136 can be pivotably coupled between side members of the frame member 126 by a shaft 138, and one or more of second linkage 140 can be pivotably coupled between the side members of the frame member 126 by a shaft 144. A hydraulic cylinder 146 can be coupled at one end to the inner surface of the end 128 of the frame member 126, and to the rear side of the linkage 136 at the opposing end, thereby providing for hydraulic control to vary the position of the linkage 136. A hydraulic cylinder 148 can be coupled at one end to a side surface of the linkage 136 and to the belt assembly 124 at the opposing end. In some embodiments, a similar hydraulic cylinder 148 can be coupled to the opposing side surface of the linkage 136 to provide for greater control of the position of the linkage 136.

The endpoints of the linkages 140, 142 can be pivotably coupled to the respective side surface of the linkage 136. One or more connecting rods 150 can be used to operably and movably couple the end surface of the linkage 136 to the belt assembly 124. The cylinders 146, 148, linkages 140, 142, and rods 150 in combination operate to control and stabilize the position of the linkage 136, thereby varying the position of the mounting assembly 122 to the belt assembly 124. For example, the frame member 126, the shaft 138, and the linkages 140, 142 can work together as a four-bar linkage to lift the belt assembly 124 out of the way for laying harvested crop under the center of the harvester 100, and lowering the belt assembly 124 into position such that the belt assembly 124 can redirect the harvester crop out of the right side of the harvester 100. By repositioning the linkage 136, the remaining members of the mounting assembly 122 are acted upon to deploy, disengage or reposition the belt assembly 124.

The belt assembly 124 includes a frame 152 including first and second opposing side surfaces 154, 156. A distal end 158 of the belt assembly 124 defines the area at which crop from the header 102 is introduced to the crop merger 104, and a proximal end 160 of the belt assembly 124 defines the area at which crop is output to the windrow. Flanges 162 mounted to the side surface 154 include openings that receive and retain a support rod (not illustrated). The support rod can be operably coupled to one or more components of the mounting assembly 122 (e.g., hydraulic cylinder 148, rods 150, or the like) such that the mounting assembly 122 can regulate the position and/or angle of the belt assembly 124.

The belt assembly 124 includes a first roller 168 pivotably mounted at or near the distal end 158 between the side surfaces 154, 156, and a second roller 166 pivotably mounted at or near the proximal end 160 between the side surfaces 154, 156. A continuous or multipart crop merger belt 170 is disposed over and looped between the rollers 166, 168. The belt assembly 124 includes one or more motors 172 (hydraulic and/or electronic motors) mounted to the frame 152. A shaft (not illustrated) of the motor 172 is operably coupled to the roller 168 such that rotation of the shaft 174 rotates the roller 168 which, in turn, rotates the belt 170. In some embodiments, the roller 166 can passively rotate as the belt 170 rotates due to friction between the belt 170 and roller 166. In some embodiments, a secondary motor substantially similar to motor 172 can be operably coupled to the roller 166. In such embodiments, the rotational speed of the shaft 174 of the motors 172 can be coordinated to ensure proper rotational speed of the belt 170. The belt assembly 124 includes a guide 165 mounted to the side surface 154 to assist in maintaining the crop on the belt 170 until output.

The belt assembly 124 includes one or more belt speed sensors 176, 178 associated with the motor 172 and/or the roller 168. In some embodiments, the sensors 176, 178 can be, e.g., an optical sensor, a non-contact sensor, a mechanical sensor, a rotary sensor, or the like. The belt speed sensors 176, 178 can be configured to measure one or more characteristics associated with components of the system 100 that can be used to determine the rotational speed of the belt 170. In some embodiments, the belt speed sensors 176, 178 can monitor and detect the rotational speed of the shaft 174 of the motor 172 in substantially real-time, and electronically transmit signals corresponding with the detected rotational speed of the shaft 174 to a controller 180 (e.g., a processing device). In some embodiments, the belt speed sensors 176, 178 can monitor and detect the rotational speed of the roller 168 (and/or roller 166) in substantially real-time, and electronically transmit signals corresponding with the detected rotational speed of the roller 168 to the controller 180.

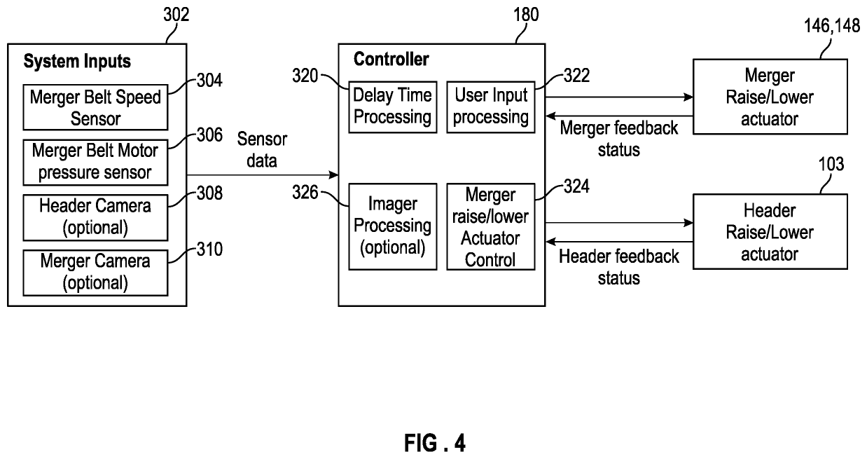

The controller 180 can determine the rotational speed of the belt 170 based on the rotational speed of the shaft 174 and/or the roller 168, and is electronically coupled to any of the GUI 116a-d. In some embodiments, the belt speed sensors 176, 178 can monitor and detect the rotational speed of the belt 170 in substantially real-time, and electronically transmit signals corresponding with the detected rotational speed of the belt 170 to the controller 180 as the motor belt speed input 304. The controller 180 can therefore determine the rotational speed of the belt 170 directly and/or indirectly from the belt speed sensor 176, 178 data as illustrated in FIG. 4.

The controller 180 can determine a merger belt motor pressure of the motor 172 based on a merger belt motor pressure sensor 182 electronically coupled to the motor 172. The merger belt motor pressure sensor 182 can monitor and detect the amount of material or cut crop on the belt 170 in substantially real-time, and electronically transmit signals corresponding with the detected cut crop on the belt 170 to the controller 180 as the merger belt motor pressure input 306. The controller 180 can therefore determine the merger belt motor pressure of the motor 172 directly and/or indirectly from the sensor 182 data as the merger belt motor pressure input 306. For example, if there is no cut crop on the belt 170 then there is none or very low pressure sensed by the merger belt motor pressure sensor 182. If there is substantial cut crop on the belt 170, then there is high pressure sensed by the merger belt motor pressure sensor 182.

As illustrated in FIG. 4, the motor belt speed input 304 and the merger belt motor pressure input 306 are provided to the controller 180. The header camera input 308 and merger camera input 310 are provided by the first and second imaging units 105, if present, to the controller 180. The controller 180 operates a delay time processing module 320, a user input processing module 322 that receives input from any of the GUI 116a-116d as described above, and a merger raise and/or lower actuator control module 324 for receiving a merger feedback status from the crop merger actuator or hydraulic cylinders 146, 148, and a header feedback status from the header actuator or hydraulic cylinder 103. The merger feedback status is used by the controller 180 to determine if cut crop remains on the crop merger belt 170. The header feedback status is used by the controller 180 to determine position and location of the header 102. The controller 180 also operates an image processing module 326 if the header camera input 308 and/or the merger camera input 310 are provided by the first and second imaging units 105, if present.

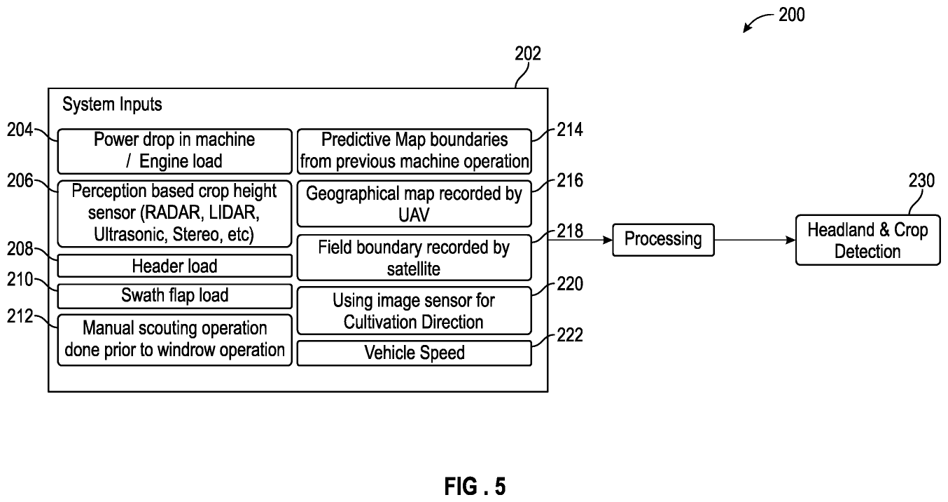

Turning now to FIG. 5 is a block diagram of operation of a headland and crop detection module 200 on the controller 180 of the header 102 and the crop merger 104. One or more system inputs 202 from the harvester 100 are provided to the headland and crop detection module 200 on the controller 180. The system inputs 202 include any of a power drop in machine or engine load input 204, a perception based crop height input 206, a header load input 208, a swath flap load input 210, a manual scouting input 212, a predictive map boundary input 214, a geographical map input 216, a field boundary input 218, a cultivation direction input 220, a vehicle speed input 222, a cutter width of the header 102, or other input that aids in identification or detection of the headland or the edge of crop. The power drop in machine or engine load input 204 is a change in the amount of power or engine load as the header 102 reaches the end of a row and exits the field thereby reducing or lowering the amount of power required by the header 102. The vehicle speed input 222 is the velocity of the header 102 and may be used in the determination of the machine or engine load input 204. A perception based crop height input 206 is based on information for a change in the height of the crop that identifies if there is crop present or no crop present in a forward looking direction of the header 102 and is provided by any of the first and second imaging units 105, radar, LiDAR or light detection and ranging, ultrasonic, radio waves, electromagnetic waves, to name a few exemplary embodiments that can provide this information. A header load input 208 is determined by the amount or weight of cut crop on the conveyor 107 of the header 102 as sensed by the one or more header actuators or hydraulic cylinders 103 or header sensor.

Continuing with FIG. 5, in some embodiments, the header 102 includes a swath flap or swath board that is supported for movement by a support structure between a raised position and a lowered position. The swath flap is configured to at least partially shape a windrow of a crop material. The swath flap deflects the cut crop material onto the ground in a belly pass or the swath flap can be raised to pass the cut crop material to the crop merger 104 in a merger pass. When the swath flap is raised or engaged, then a load is experienced on a swath flap sensor associated with the swath flap to indicate the crop is present on the swath flap and provides a swath flap load input 210 that indicates the header 102 remains in the crop field and has not exited the crop field. As the header 102 exits the crop field there is there is no cut crop on the swath flap which corresponds to a change in the swath flap load experienced by the swath flap sensor and provides the swath flap load input 210 that indicates the header 102 has exited the crop field.

Continuing with FIG. 5, a manual scouting input 212 includes a manual scouting operation done or performed by an operator that determines the crop area and then enters this into the controller 180. A predictive map boundary input 214 includes a map boundary of the crop area determined from previous or earlier operation of other machines that are not the harvester 100 and communicated to the controller 180. A geographical map input 216 includes a geographical map of the crop field or area and headland recorded by an unmanned aerial vehicle or UAV and communicated to the controller 180. A field boundary input 218 includes a crop area recorded by a satellite or other means and transmitted to the controller 180. A cultivation direction input 220 includes detection of cultivation or planting of the crop field to indicate the crop area wherein the detection can be performed by any of the first and second imaging units 105, radar, LiDAR or light detection and ranging, ultrasonic, radio waves, electromagnetic waves, to name a few exemplary embodiments that can provide this information. The controller 180 receives one or more of the system inputs 202-222 and determines a headland and crop detection 230 that includes an identification of the headland and crop edge as the header 102 approaches. The headland and crop detection 230, in some embodiments, determines the distance to the headland and/or crop edge and accounts for the travel velocity of the harvester 100 and the header 102 as the harvester 100 approaches the headland.

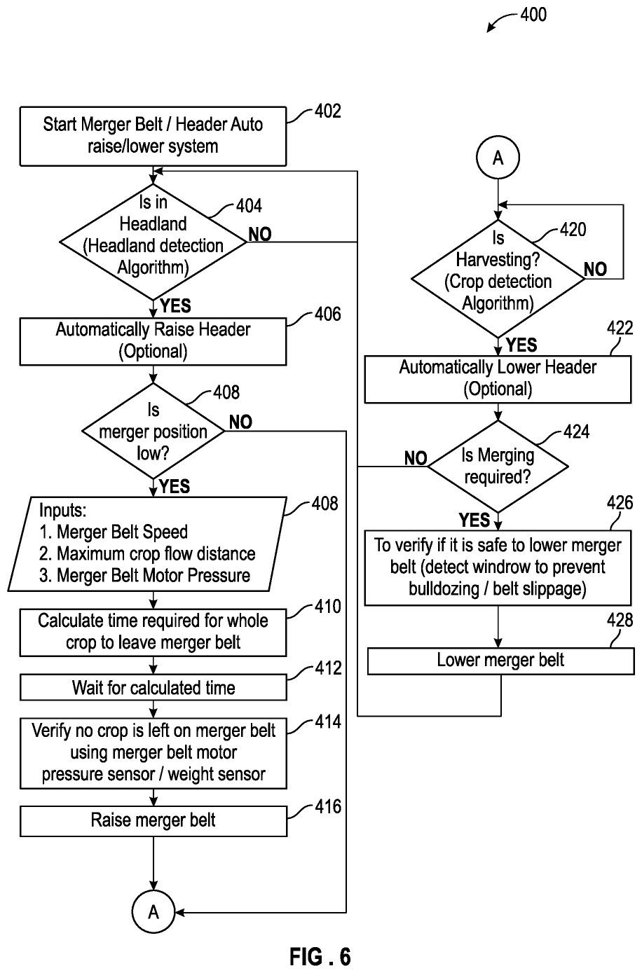

Turning now to FIG. 6 is an exemplary method 400 of operating the header 102 and crop merger 104 of the harvester 100 to automatically raise and/or lower the header 102 and the crop merger 104. In step 402, the operator through any of the GUI 116a-116d can enable the automatic operation of the header 102 and crop merger 104. In other embodiments, the controller 180 can enable the automatic operation of the header 102 and crop merger 104. For example, the operator may initiate a triggering event that causes the controller 180 to enable the automatic operation of the header 102 and crop merger 104. In step 404, the controller 180 operates the headland and crop detection module 200 as discussed above to determine if the headland is present or the header 102 is approaching the headland. If the header 102 is not approaching the headland, then the controller 180 continues to operate the headland and crop detection module 200. If the header 102 approaches the headland, then optionally at step 406 the controller 180 controls the one or more header actuators or hydraulic cylinders 103 to raise the header 102.

In response to the header 102 approaching the headland at step 408, the controller 180 determines if the crop merger belt 170 is in a low position. If the crop merger belt 170 is in a high position, then the method 400 continues to step 420. If the crop merger belt 170 is in a low position, then at step 410 the controller 180 receives a merger belt speed provided by the belt speed sensor 176, 178, a maximum crop flow distance, and a merger belt motor pressure provided by the merger belt motor pressure sensor 182. At step 412, the controller 180 determines or calculates the time required for substantially all of the cut crop presently on the crop merger belt 170 to dispense from the crop merger belt 170 onto the ground surface or cut crop area of the field based on any of the merger belt speed provided by the belt speed sensor 176, 178, the maximum crop flow distance, and the merger belt motor pressure provided by the merger belt motor pressure sensor 182.

At step 414, the controller 180 controls operation of the crop merger belt 170 for the determined or calculated time to empty or substantially empty the cut crop from the crop merger belt 170 onto the ground surface. At step 416, the controller 180 receives the merger belt motor pressure from the merger belt motor pressure sensor 182 or a weight sensor to determine if cut crop remains on the crop merger belt 170. At step 418, the controller 180 controls the one or more crop merger actuators or hydraulic cylinders 146, 148 to raise the crop merger belt 170.

At step 420, the controller 180 determines if there is crop that needs to be cut or harvested. If there is no crop detected by the controller 180, then the method 400 continues until the controller 180 determines there is crop to harvest. At step 422, if there is crop to be harvested, then the controller 180 controls the one or more header actuators or hydraulic cylinders 103 to lower the header 102 into a harvesting mode of operation to cut the crop.

In step 424, the method 400 continues such that the controller 180 determines if merging of the cut crop is required. The controller 180 determines that merging of the cut crop is required by detecting the cut crop intake from the imaging unit 105 mounted on the header 102 and/or the imaging unit 105 mounted on the crop merger 104. If the controller 180 determines that no merging of the cut crop is required, then the method 400 continues to step 404 to determine if the header 102 is approaching the headland as described above.

If the controller 180 determines that merging of the cut crop is required then at step 426, the method 400 continues and the controller 180 verifies or determines it is safe to lower the crop merger belt 170 by detecting a windrow is present to prevent bulldozing and slippage of crop merger belt 170. At step 430, the method 400 continues and the controller 180 controls the one or more crop merger actuators or hydraulic cylinders 146, 148 to lower the crop merger belt 170. After step 430, the method 400 returns to step 424 for the controller 180 to continue to determine if merging of the cut crop is required.

While this disclosure has been described with respect to at least one embodiment, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

1. A method for operating a harvester machine, the method comprising:
determining, via a controller, whether a header operably attached to the harvester machine is approaching a headland;
in response to the header approaching the headland, determining, via the controller, whether a crop merger operably attached to the harvester is in a low position;
in response to the crop merger being in the low position, determining, via the controller, an amount of crop material on the crop merger using one or more of a merger belt speed provided by a belt speed sensor associated with a crop belt of the crop merger, a maximum crop flow distance, and a merger belt motor pressure provided by a merger belt motor pressure sensor associated with a motor of the crop merger;
determining, via the controller, whether a crop material remains on the crop merger by the merger belt motor pressure provided by the merger belt motor pressure sensor associated with the motor of the crop merge; and
commanding via the controller a crop merger actuator to move the crop merger to a raised position when the crop merger does not contain the crop material.

2. The method of claim 1, further comprising:
determining a time period required for dispersion of the crop material from the crop belt of the crop merger.

3. The method of claim 2, further comprising:
after the time period has passed, then the determining via the controller whether the crop material remains on the crop merger.

4. The method of claim 1, further comprising:
receiving a user command from an operator via a user interface operably connected with the controller to enable the controller to perform automatically.

5. The method of claim 1, further comprising:
receiving one or more operational inputs from the operator via the user interface that includes any of a maximum ground speed of the harvester, a minimum ground speed of the harvester, a maximum delay time between raising the header and raising the crop merger, a minimum delay time between raising the header and raising the crop merger, a maximum delay time between lowering the header and lowering the crop merger, a minimum delay time between lowering the header and lowering the crop merger.

6. The method of claim 1, wherein the commanding via the controller the crop merger actuator to move the crop merger to a raised position is performed automatically.

7. The method of claim 1, wherein the determining, via the controller, whether the header operably attached to the harvester machine is approaching the headland includes receiving one or more harvester system inputs that identify the headland.

8. The method of claim 7, wherein the harvester system inputs include any of a power drop in engine load input of the header, a perception based crop height input, a header load input, a swath flap load input, a manual scouting input, a predictive map boundary input, a geographical map input, a field boundary input, a cultivation direction input, a cutter width of the header, and a vehicle speed input.

9. The method of claim 1, wherein in response to the header approaching the headland, commanding via the controller one or more header actuators to raise the header to a raised position.

10. The method of claim 1, further comprising:
determining via the controller whether crop is present on the ground for harvesting by an imaging unit that detects crop, the imaging unit mounted on the header and/or the crop merger and operably connected to the controller; and
commanding via the controller a header actuator to lower the header to a harvesting mode of operation to cut the crop in response to determining crop is present on the ground.

11. The method of claim 10, further comprising:
determining via the controller whether merging of the cut crop is required;
detecting the cut crop from the imaging unit.

12. The method of claim 11, further comprising:
wherein the determining whether merging of the cut crop is required includes detecting a windrow of cut crop on the ground or detecting a predefined merging strategy; and
in response to detecting the windrow, commanding via the controller actuating a crop merger actuator to lower the crop merger belt to a lowered position.

13. A harvester machine, comprising:
a header operably attached to the harvester machine;
a crop merger operably attached to the harvester machine, the crop merger configured to receive cut crop from the header;
a controller operably connected with the header and the crop merger, the controller configured to determine if the header is approaching a headland;
wherein the controller is configured to determine whether the crop merger is in a low position in response to the header approaching the headland;
in response to the crop merger being in the low position, the controller is configured to determine if a crop material is present on the crop merger using one or more of a merger belt speed provided by a belt speed sensor associated with a crop belt of the crop merger, a maximum crop flow distance, and a merger belt motor pressure provided by a merger belt motor pressure sensor associated with a motor of the crop merger; and
in response to substantially no crop material remaining on the crop merger, the controller is configured to command a crop merger actuator to move the crop merger to a raised position.

14. The harvester machine of claim 13, wherein the controller is configured to receive the merger belt motor pressure provided by the merger belt motor pressure sensor associated with the motor of the crop merger to determine whether the crop material remains on the crop merger.

15. The harvester machine of claim 13, wherein the controller determines a time period required for dispersion of the crop material from the crop belt of the crop merger.

16. The harvester machine of claim 13, further comprising:
a user command received from an operator via a user interface operably connected with the controller to enable the controller to perform automatically.

17. The harvester machine of claim 13, further comprising:
wherein in response to the header approaching the headland, the controller is configured to command one or more header actuators to raise the header to a raised position.

18. The harvester machine of claim 13, further comprising:
wherein the controller is configured to determine if there is crop in a field for harvesting by an imaging unit that detects crop, the imaging unit mounted on the header and/or the crop merger and operably connected to the controller; and
the controller is configured to command a header actuator to lower the header to a harvesting mode of operation to cut the crop in response to crop being present for harvesting.

19. The harvester machine of claim 18, further comprising:
wherein the controller is configured to determine whether the cut crop should be merged; and
wherein the controller is configured to detect the cut crop from an imaging unit mounted on the header and/or the crop merger.

20. The harvester machine of claim 18, further comprising:
wherein the controller is configured to detect a windrow of cut crop on the ground; and
in response to the detected windrow, the controller is configured to actuate a crop merger actuator to lower the crop merger belt to a lowered position.
